(19) United States
(12) Patent Application Publication
(10) Pub. No.: US 2001/0051987 A1
(43) Pub. Date: Dec. 13, 2001

(54) E-mail system and E-mail transmission method of broadcasting

(76) Inventors: Koji Fukumoto, Tokyo (JP); Shinji Tatsutomi, Tokyo (JP)

Correspondence Address: STAAS & HALSEY LLP, 700 11TH STREET, NW, SUITE 500, WASHINGTON, DC, 20001, US

(21) Appl. No.: 09/781,329

(22) Filed: Feb. 13, 2001

(30) Foreign Application Priority Data
Jun. 5, 2000 (JP) 2000-166953

(51) Int. Cl. G06F 15/16

(52) U.S. Cl. 709/206; 709/203

(57) ABSTRACT

When transmitting a broadcasting E-mail, a sender designates a transmission destination of an emphasized part for each item. A mail server automatically emphasizes and highlights the items corresponded by the E-mail for each designated transmission destination of the emphasized part to be distributed. Further, the mail server can emphasize and highlight the keyword for each receiver included in the E-mail to be transmitted to each receiver.

### BACKGROUND OF THE INVENTION

1. Field of the Invention

The present invention relates to an E-mail system and a method for transmitting broadcast E-mails to a plurality of receivers.

2. Description of the Related Art

Today, when homework is assigned at a conference and other meetings, a method of appending the name of a person who is in charge of handling the homework, at the right edge of the corresponding item described in the E-mail minutes, thereby gaining the attention of a receiver, is often used. Further, when a certain sentence is displayed on the screen of a display, a method of emphasizing and displaying the important part in the sentence, is also used daily.

However, the broadcasting method using E-mail has been generalized as the means of effectively transmitting information to many receivers at once. Here, broadcasting is used to transmit information to a plurality of receivers at once.

However, there are the following problems in the conventional broadcasting of minutes using E-mail.

Today, the transmission and reception of information using E-mail is actively carried out everyday. However, it is very troublesome for a receiver to read many E-mails in a short time. If, at this time, there was a method of reading the received mails effectively, it would be beneficial to the receiver.

Especially with the broadcast E-mail, there are many cases that it is not necessary to thoroughly read the entire contents, and the part related to each receiver is limited. Therefore, a document style such that the receiver can recognize the important parts at a glance, is desirable.

However, it is not sufficient only to indicate a receiver's name at the side of the related item as in conventional minutes. There are also many cases in which the receivers consider different parts of the received document as important parts. Accordingly, even if an emphasized and displayed part is present, the part is not necessarily important to all the receivers.

Thus, it is conceivable to transmit individual E-mails with different emphasized parts for each receiver. However, in the case that there are many receivers, it is a serious burden to a sender to emphasize and display each important part and thereby have to prepare a plurality of documents.

### SUMMARY OF THE INVENTION

It is an object of the present invention to provide an E-mail system and a method thereof for transmitting a broadcast E-mail which enables each receiver to easily recognize the important part.

The E-mail system of the present invention is provided with a receiving device, emphasizing device, and transmitting device. The receiving device receives transmission information transmitted from a sender to a plurality of receivers. The emphasizing device emphasizes and expresses the received transmission information for each receiver, thereby preparing E-mail information for each receiver. The transmitting device transmits the E-mail information prepared for each receiver.

### BRIEF DESCRIPTION OF THE DRAWINGS

FIG. 1 is a block diagram showing the principle of the E-mail system of the present invention;

FIG. 2 is a configuration diagram of the E-mail system;

FIG. 3 is a diagram showing the first transmitting process;

FIG. 4 is a flowchart of a process of the first client;

FIG. 5 shows the first transmission document;

FIG. 6 shows the second transmission document;

FIG. 7 a flowchart of a process of the first mail server;

FIG. 8 shows a sender table;

FIG. 9 shows the first mail received by Yamada;

FIG. 10 shows the first mail received by Tamura;

FIG. 11 shows the first mail received by Murayama;

FIG. 12 shows the first mail received by Kamikawa;

FIG. 13 shows the first mail received by Yamakawa/Uemura;

FIG. 14 shows the second transmitting process;

FIG. 15 is a flowchart of a process of the second client;

FIG. 16 shows the third transmission document;

FIG. 17 shows a keyword table;

FIG. 18 a flowchart of a process of the second mail server;

FIG. 19 shows the second mail received by Yamada;

FIG. 20 shows the second mail received by Tamura;

FIG. 21 shows the second mail received by Murayama;

FIG. 22 shows the second mail received by Yamakawa;

FIG. 23 shows the second mail received by Kawakami;

FIG. 24 shows the second mail received by Uemura;

FIG. 25 is a configuration drawing of an information processor; and

FIG. 26 shows a storage medium.

### DESCRIPTION OF THE PREFERRED EMBODIMENTS

The following is a detailed explanation of the embodiments of the present invention in reference to the diagrams.

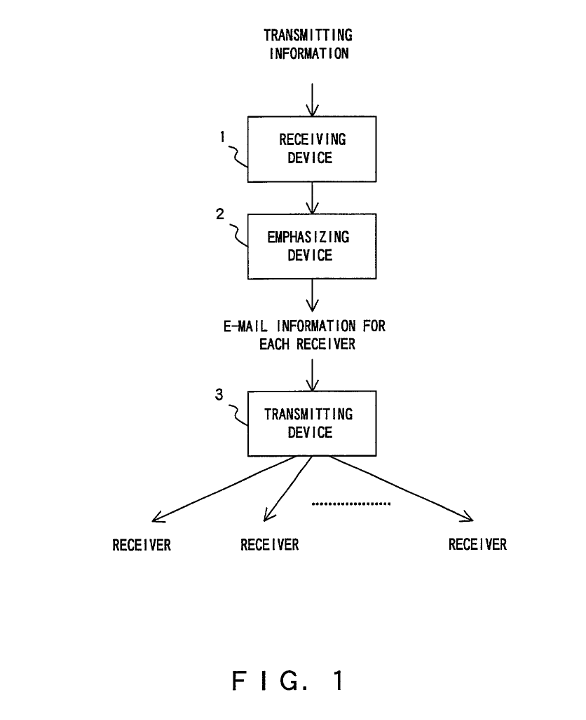

FIG. 1 is a block diagram showing the principle of the E-mail system of the present invention. The E-mail system of FIG. 1 is provided with a receiving device 1, emphasizing device 2, and transmitting device 3.

The receiving device 1 receives the transmission information transmitted to a plurality of receivers from a sender. The emphasizing device 2 emphasizes and expresses the received transmission information for each receiver, thereby preparing E-mail information for each receiver. The transmitting device 3 transmits the E-mail information to each receiver.

When the receiving device 1 receives the transmission information transmitted from the sender, it passes the information to the emphasizing device 2. The emphasizing device 2 automatically emphasizes and highlights the part which is related to each receiver in the transmission information, for each receiver, thereby preparing E-mail information which differs for each receiver. The transmitting device 3 transmits the E-mail information prepared for each receiver, to the corresponding receiver. In this way, only the part which is related to the receiver in the transmission information, is emphasized and displayed on the terminal of each receiver.

According to such an E-mail system, when a sender transmits broadcast E-mail, the part related to a receiver is automatically emphasized and displayed on the terminal of each receiver. Since the part related to the receiver is usually important to the receiver, the part is emphasized and displayed, so that the receiver can easily recognize the important part.

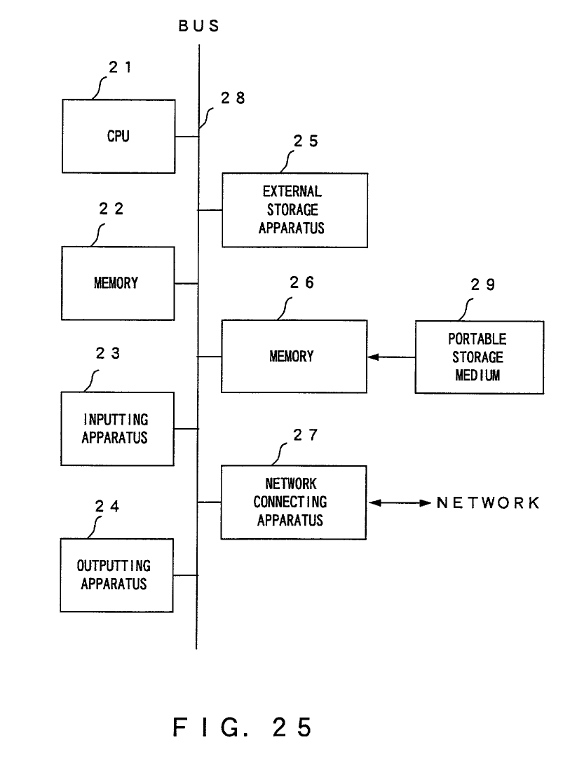

For example, the receiving device 1 and transmitting device 3 of FIG. 1 correspond to a network connecting apparatus 27 of FIG. 25 that is described later. The emphasizing device 2 of FIG. 1 corresponds to a CPU central processing unit) 21 and memory 22 of FIG. 25.

The received document only including emphasis is not sufficient for the receiver of the broadcasting E-mail. Therefore, it is desirable that only the part that is important for the receiver is emphasized and displayed. Thus, in this embodiment, the emphasis specific to each receiver is automatically included in the broadcast E-mail prepared by the sender, thereby transmitting the thus included E-mail.

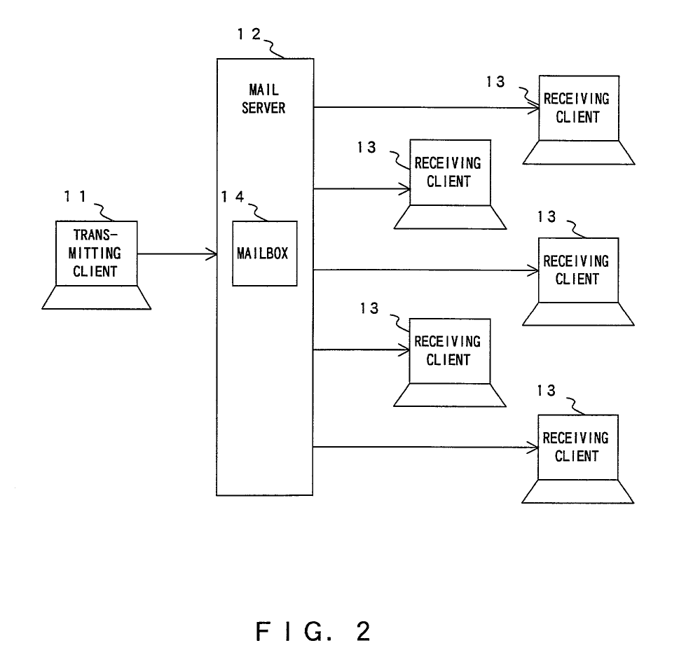

FIG. 2 is a diagram showing the configuration of such an E-mail system. The system of FIG. 2 includes a transmitting client 11, a mail server 12, and a plurality of receiving clients 13. These clients 11 and 13, and the mail server 12 are connected by a communication network. The clients 11 and 13 correspond to the terminal of the user that uses the E-mail system.

The sender of broadcast E-mail prepares a transmission document on the transmitting client 11, and transmits the prepared document to the mail server 12. At this time, the transmitting client 11 instructs the mail server 12 to transmit to each receiver the E-mail that is prepared by emphasizing and highlighting a transmission document for each receiver.

The mail server 12 allocates the transmission documents to the respective destinations, it emphasizes and highlights the related part for each destination, and stores the documents in the mailbox 14. Then, the transmission document is transmitted to the receiving client 13 corresponding to the destination. On the screen of each receiving client 13, the part related to the receiver in the transmission document is emphasized and displayed with the designated highlighting method.

The method of emphasizing and highlighting the related part can be optionally selected. For example, there are various methods such as coloring the part to be emphasized so it is different from the other part, writing the part in a different style, writing the part in a bold type, underlining the part, enclosing the part in a frame, screening the part, or the like. Further, as for a method of selecting the part that should be emphasized to be expressed for each receiver, the following two methods are conceivable:

(1) A sender divides a transmission document into a plurality of blocks. The block that is thought to be deeply related for each receiver, is designated as the part to be emphasized and highlighted.

(2) A sender sets in advance a predetermined keyword for each receiver. In the case that a system retrieves a transmission document, and detects the part matching the keyword, it designates the part as the part to be emphasized and highlighted for the corresponding receiver.

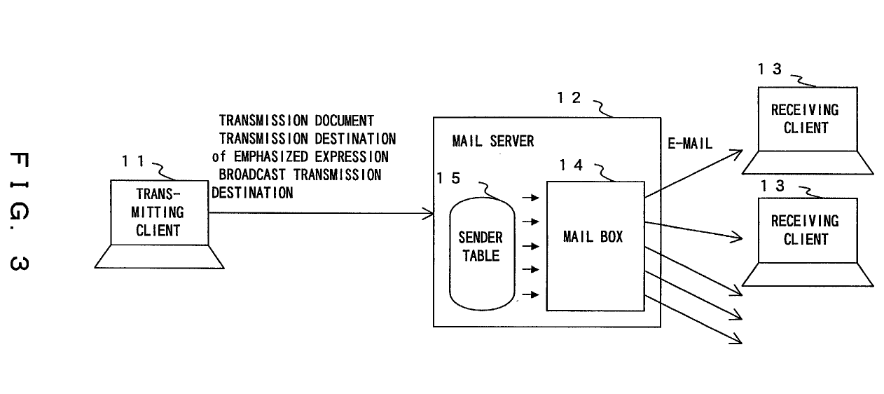

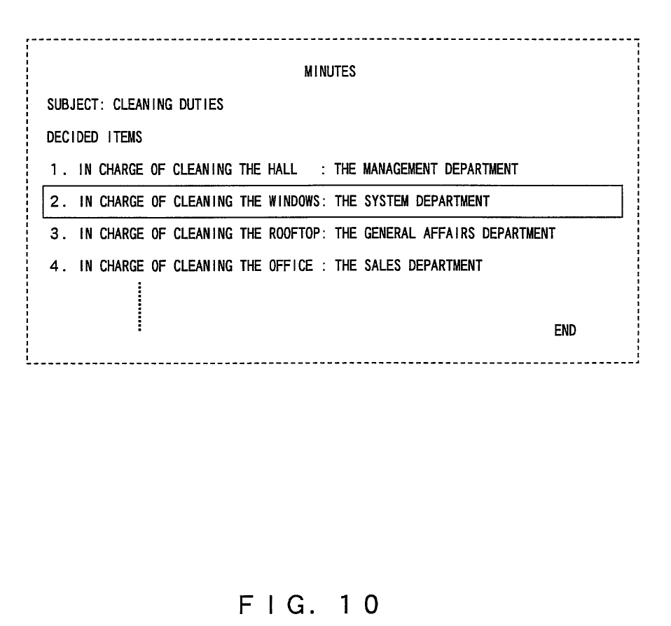

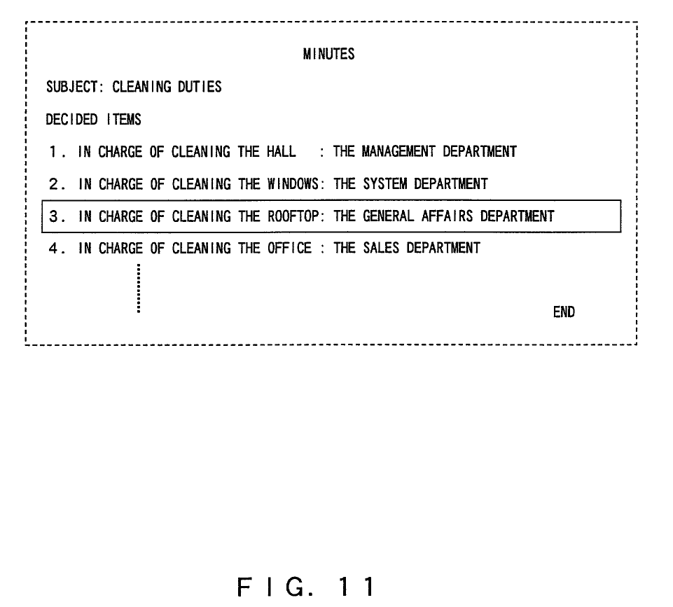

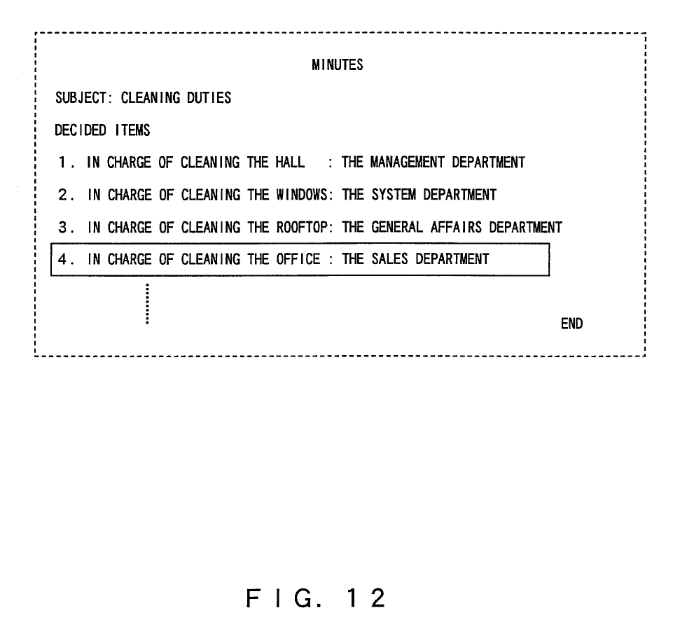

First, the transmitting process based on the above-mentioned selecting method (1) is explained with reference to FIGS. 3 to 13.

FIG. 3 shows the transmitting process performed in the E-mail system of FIG. 2. First, a sender prepares a transmission document on the client 11, designates the part to be emphasized and highlighted for each destination (receiver), and transmits the document to the mail server 12. With reference to a sender table 15, the mail server 12 stores the transmission document which includes a part to be emphasized and highlighted for each receiver, in a mail box 14, and transmits the document to the client 13.

In the sender table 15 as well as a broadcasting table for controlling the broadcasting, a broadcast identifier, and the group, name, and mail address of a receiver are recorded. A sender designates at the time of sending E-mail a destination using the broadcast identifier. The mail server 12 sends E-mails to a plurality of mail addresses corresponding to the broadcast identifier.

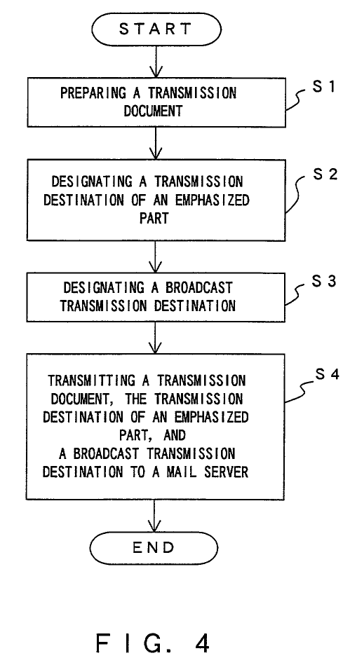

FIG. 4 is a flowchart showing the process of the client 11 in this case. First, the client 11 prepares a transmission document based on the information which the sender inputs on a screen (step S1), and adds the transmission destination of the emphasized part that is designated by the sender, to the transmission document (Step S2).

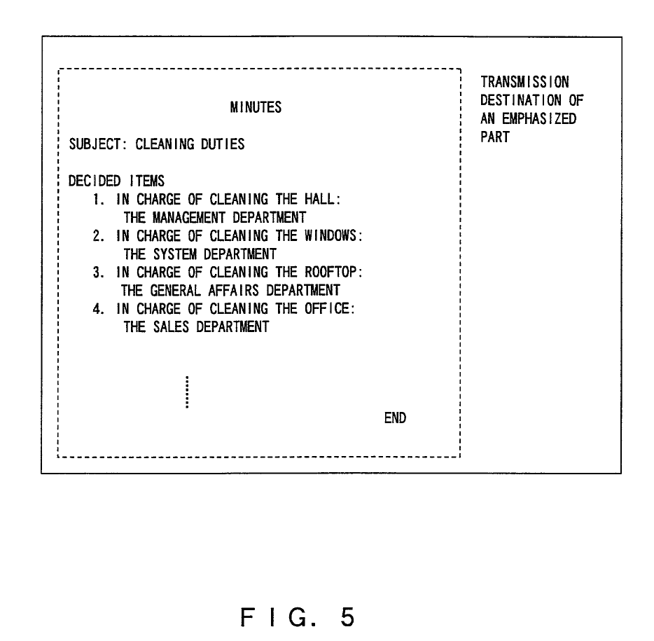

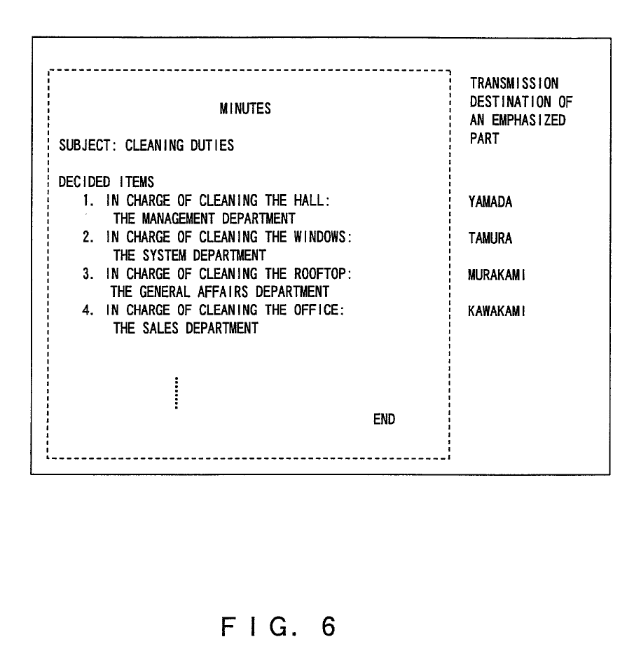

In the case that the transmission document of the minutes regarding the work-sharing is prepared, for example, as shown in FIG. 5, the sender inputs the transmission destination of the emphasized part in each item of the decision items on the right edge. As for the information for designating the transmission destination of the emphasized part, anyone of the group, name, and mail address that are recorded in the sender table 15, is used. In the case that the sender inputs the name of a receiver, for example, a transmission document like FIG. 6 is formed.

In FIG. 6, “Yamada”, “Tamura”, “Murayama” and “Kawakami” are designated as the transmission destinations of the emphasized part of items 1, 2, 3, and 4, respectively. Here, one receiver is designated for one item, but a plurality of receivers can be designated as transmission destinations of the emphasized part. Further, it is also possible that other attribute information (age, sex, address, etc.) that designates a receiver, is registered in the sender table 15, thereby designating the transmission destinations of the emphasized part using the information.

Next, the client 11 adds the broadcast identifier designated by the sender to the transmission document as the broadcast transmission destination (step S3).

Then, the client 11 transmits the transmission document, the transmission destination of the emphasized part, and the information about broadcast transmission destinations to the mail server 12, and it instructs the mail server 12 to transmit the E-mail that is obtained by emphasizing and highlighting an important part in the transmission document for each receiver, to each receiver (step S4), thereby terminating the processes.

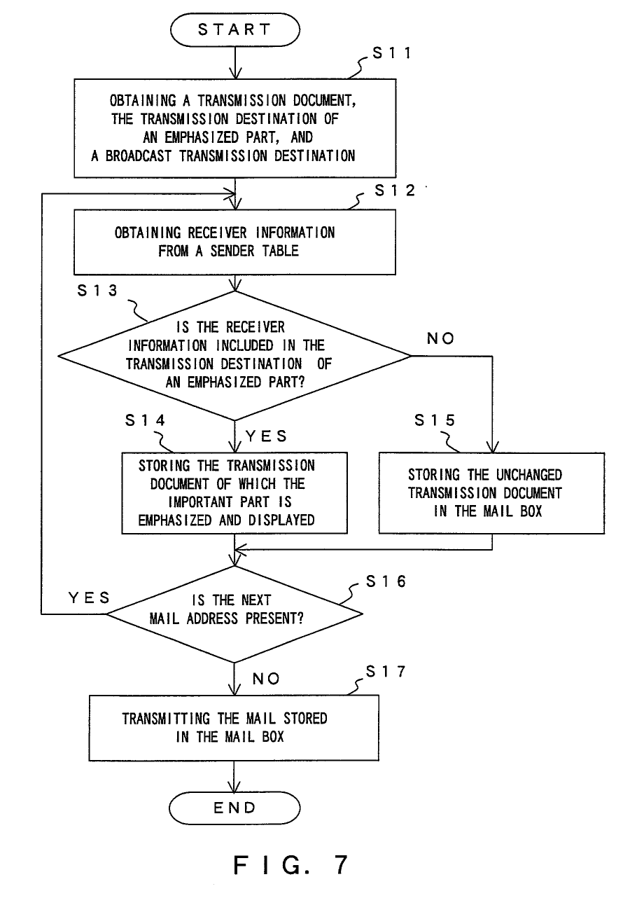

FIG. 7 is a flowchart showing the processes performed by the mail server 12 that receives information from the client 11. The mail server 12 first obtains the transmission document, transmission destination of the emphasized part, and information about broadcast transmission destinations (step S11), and obtains the receiver information about one receiver corresponding to the broadcast transmission destinations, from the sender table 15 (step S12).

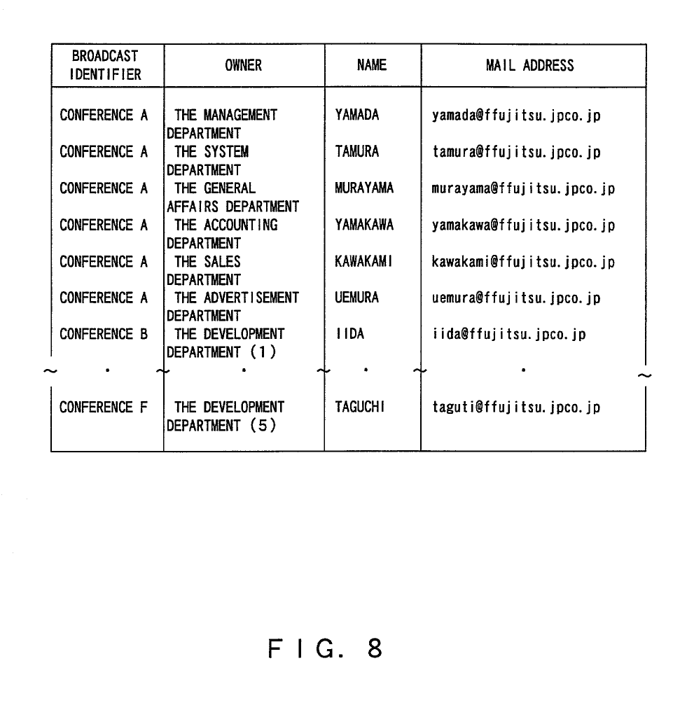

FIG. 8 shows an example of the sender table 15. In this sender table, “Conference A”, “Conference B”, etc., are registered as broadcast identifiers. As the receivers who belong to “Conference A”, six people, including “Yamada”, “Tamura”, “Murayama”, “Yamakawa”, “Kawakami”, and “Uemura”, are registered. In the case that: the broadcast identifier designated by a sender is “Conference A”, the mail server 12 first acquires the mail address and name of “Yamada” as the receiver information from this sender table.

Next, it is checked whether the obtained receiver information is included in the transmission destination of the emphasized part (step S13). Here, it is checked whether the character string corresponding to the name of the receiver is included in the transmission destination of the emphasized part. If such a character string is present, it is determined that the receiver information is included in the transmission destination of the emphasized part.

Further, in the case that other information such as group, mail address of the receiver, etc., are designated as a transmission destination of the emphasized part, the corresponding receiver information is obtained from the sender table 15, and it is checked whether the character string is included in the transmission destination of the emphasized part.

If the receiver information is included in the transmission destination of the emphasized part, the corresponding part of the transmission document is emphasized and highlighted, and the information is stored in the area corresponding to the mail address of the mailbox 14 (step S14). If the receiver information is not included in the transmission destination of the emphasized part, the transmission document is directly stored in the mailbox 14 (step S15).

For example, in the case of “Yamada” of FIG. 8, the receiver information is included in the transmission destination of the emphasized part of FIG. 6. Therefore, the part, “1. in charge of cleaning the entrance: The management department”, that corresponds to this location is emphasized and highlighted, and is stored in the area corresponding to the mail address of “Yamada”.

Next, it is checked whether the next receiver corresponding to the broadcast transmission destination is registered in the sender table 15 (step S16). If such a receiver is remaining, processes in and after step S12 are repeated.

In this way, the mail addresses and names of “Tamura”, “Murayama”, “Yamakawa”, “Kawakami”, and “Uemura” of the sender table of FIG. 8 are sequentially acquired. The transmission document of each receiver is stored in the mailbox 14.

Then, when the transmission documents of all the receivers of the broadcast transmission destinations are stored in the mailbox 14, the transmission documents are transmitted to the client 13 as mail (step S17), and the processes terminate.

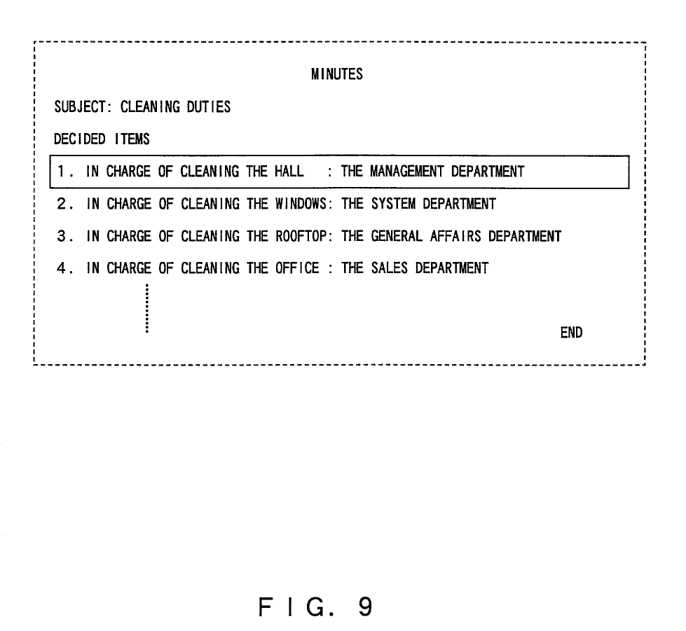

In this way, the received mails, as shown in FIGS. 9, 10, 11, and 12, are individually displayed on the client screens of “Yamada”, “Tamura”, “Murayama”, and “Karikawa ” that are designated as transmission destinations of the emphasized part in FIG. 6. The part related to each receiver is enclosed in a rectangular frame to be emphasized and highlighted in the received mail.

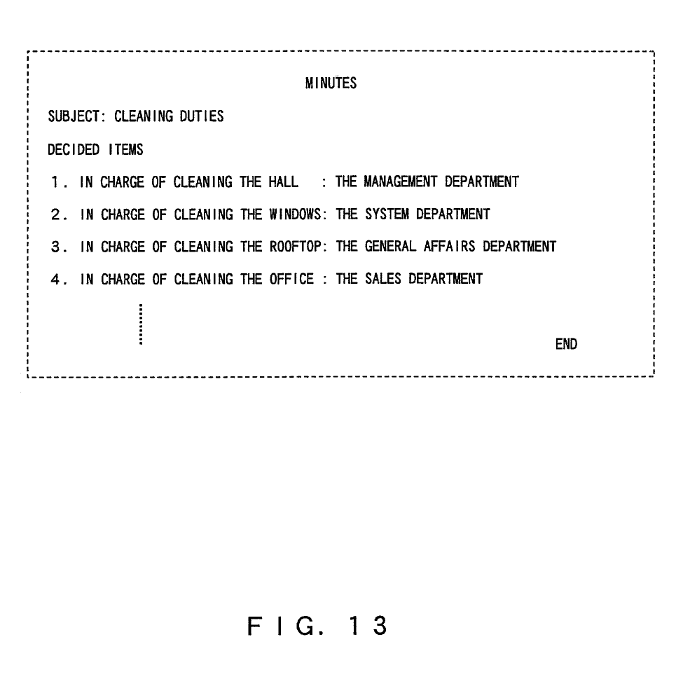

However, the received mail, as in FIG. 13, is displayed on the client screens of “Yamakawa” and “Uemura”. This is because these receivers are not designated as transmission destinations of the emphasized part, so that the emphasized display is not included in the received mail of FIG. 13.

According to such a transmitting process, a sender can send the broadcast E-mail including the emphasized part that differs for every receiver, only by designating receivers who are thought to be deeply related to each item of the transmission document. Therefore, the sender need not prepare an individual E-mail for each receiver.

For the receiver, also, the part in the received mail that he or she must pay attention to can be identified at glance, so that the important part is not be missed. In addition, the receiver can skip all parts except for the emphasized and displayed part, so that he or she can effectively read many E-mails.

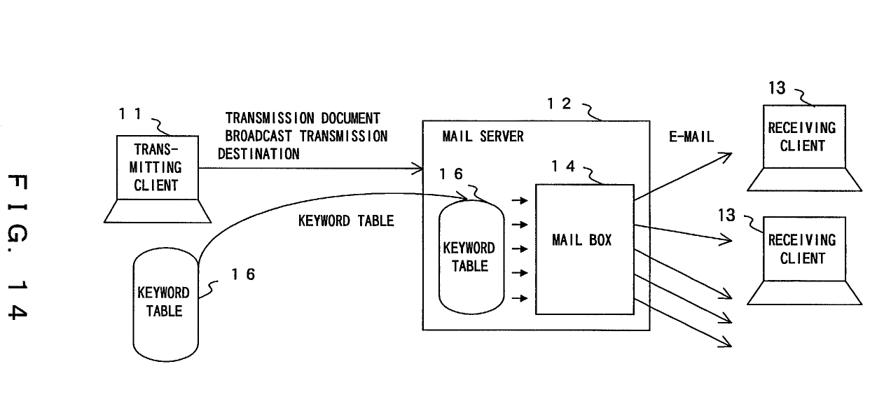

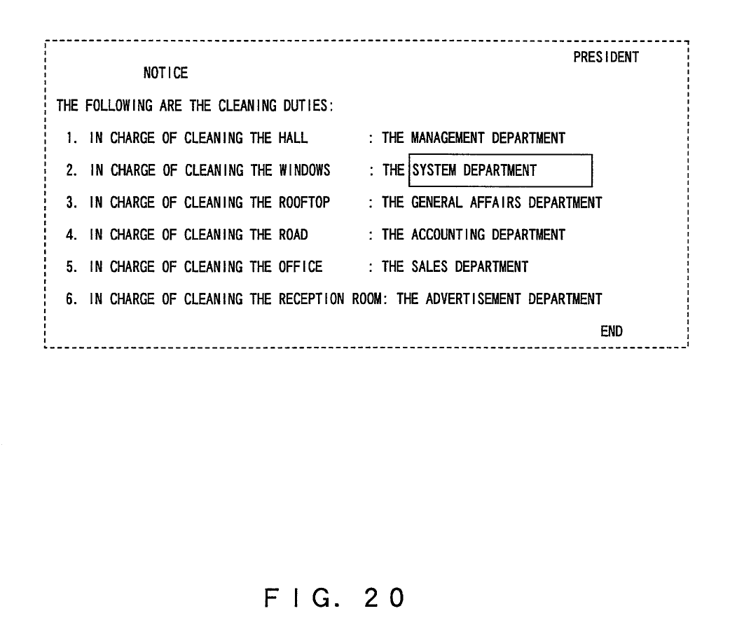

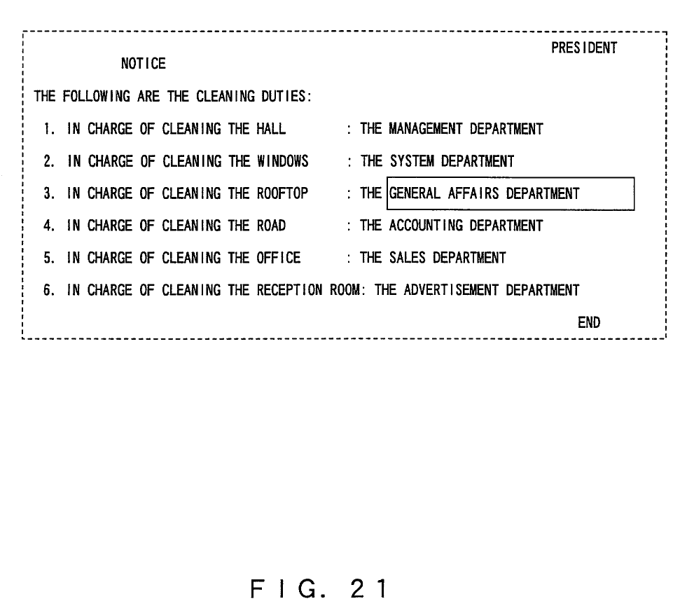

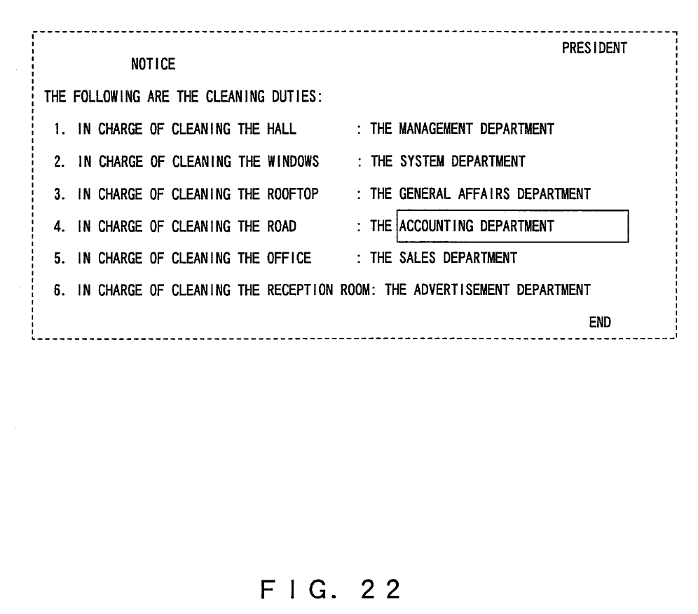

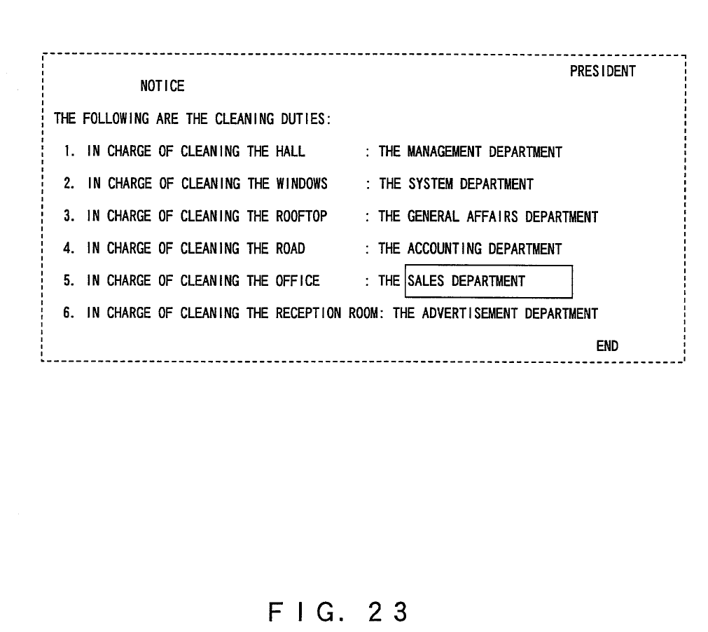

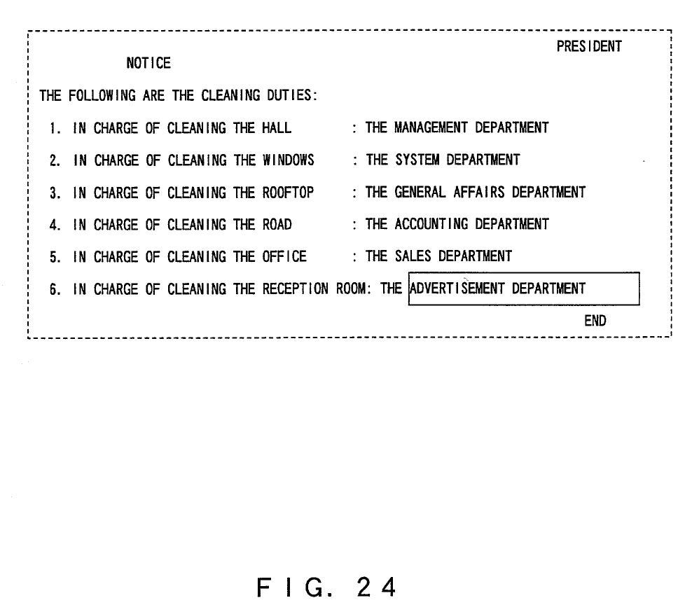

Next, the transmitting process performed based on the above-mentioned selecting method (2) is explained in reference to FIGS. 14 to 24.

FIG. 14 shows such a transmitting process performed in the E-mail system of FIG. 2. First, a sender prepares on the client 11 a transmission document and keyword table 16 to be transmitted to the mail server 12. The mail server 12 decides the part to be emphasized and highlighted in the transmission document for each receiver in reference to the keyword table 16. Then, the transmission document with the emphasized part that is included in the part, is stored in the mailbox 14 to be transmitted to the client 13.

The keyword table 16 has such a structure that an emphasis keyword designated for each receiver is added to the above-mentioned sender table 15. Therefore, the sender can designate a transmission destination using a broadcast identifier similar to the case of FIG. 3. In the transmission document, the mail server 12 retrieves the same character string as the emphasis keyword of each receiver of the keyword table 16. If a character string matching the keyword is present, E-mail that emphasizes and highlights the character string is prepared to be transmitted to the mail address of the corresponding receiver.

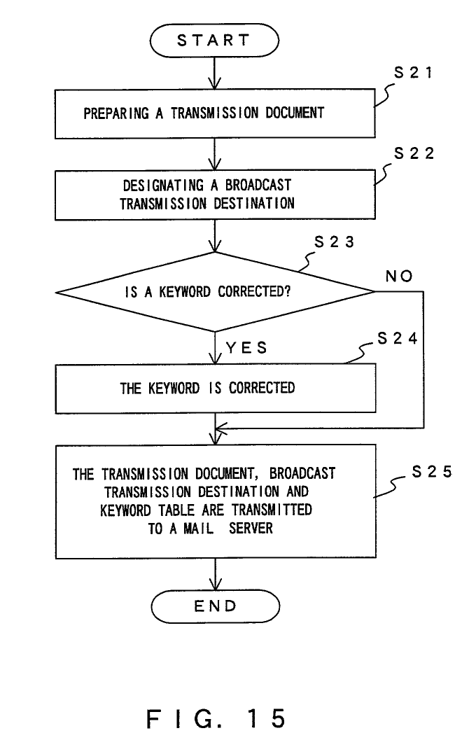

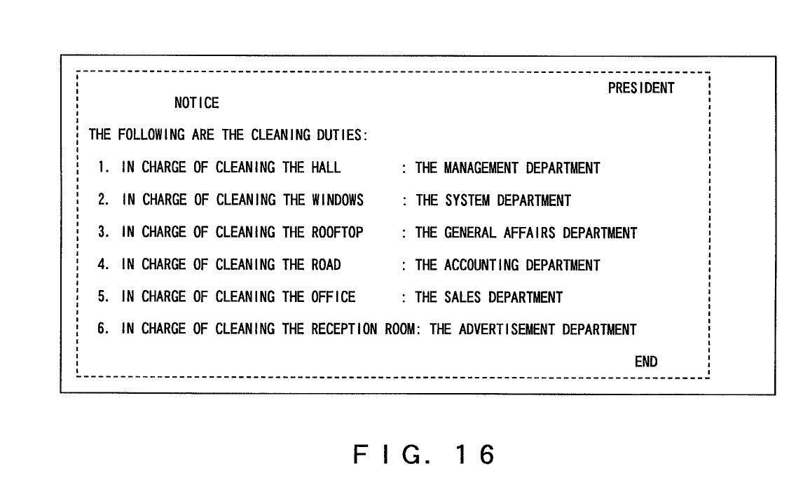

FIG. 15 is a flowchart showing the process performed by the client 11 in this case. The processes performed in steps S21 and S22 of FIG. 15 are similar to the processes performed in steps S1 and S3 of FIG. 4. Here, the transmission document that is a notification from the president regarding work-sharing, for example, as shown in FIG. 16, is prepared, thereby designating “Conference A” as a broadcast identifier.

Next, the client 11 asks the sender as to whether the keyword table 16 that is prepared in advance, should be modified (step S23). If the modification indication is input, the keyword table 16 is modified in accordance with the instruction (step S24). Then, the client 11 transmits the transmission document, broadcast transmission destination, and information of the keyword table 16 to the mail server 12. Then, the client 11 instructs the mail server 12 to transmit the E-mail that is prepared by emphasizing and highlighting the transmission document for each receiver, to each receiver (step S25), thereby terminating the processes.

If the indication that a keyword table 16 under the present condition is used is input in step S23, the process in step S25 is performed without modification, and the processes terminate.

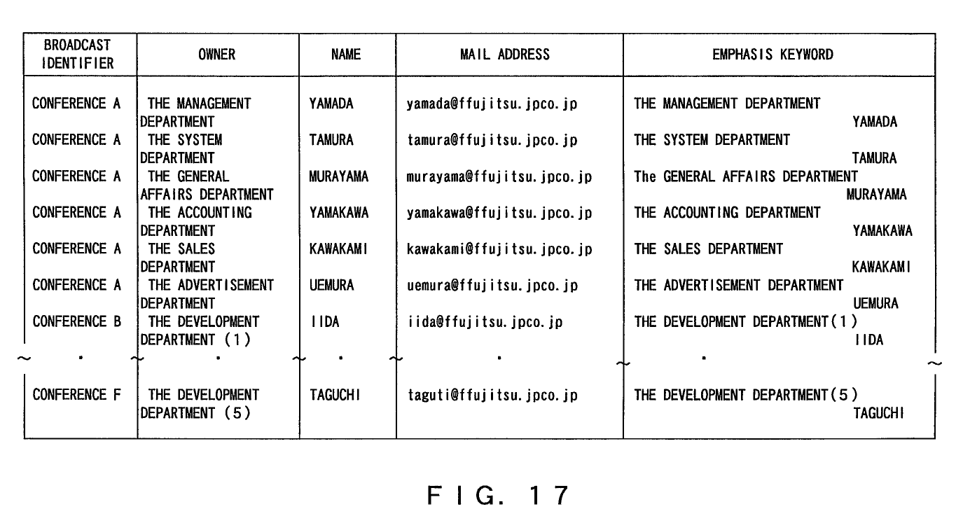

FIG. 17 shows an example of the keyword table 16. In the keyword table, the broadcast identifier, group, name, and mail address are registered in a fashion similar to the sender table of FIG. 8. Furthermore, an emphasis keyword is added. For example, as the emphasis keywords of “Yamada”, “Tamura”, “Murayama”, “Yamakawa”, “Kawakami”, and “Uemura” that belong to “Conference A”, “The management department”, “The system department”, “The general affairs department”, “The accountants' department”, “The sales department”, and “The advertisement department” are registered, respectively.

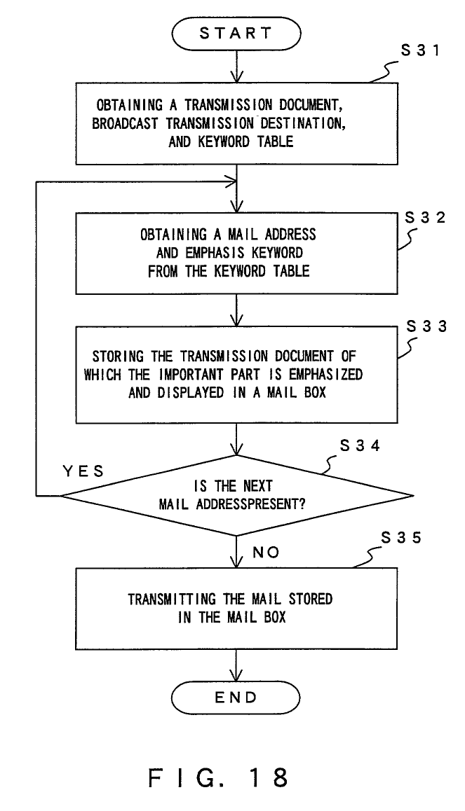

FIG. 18 is a flowchart showing the processes performed by the mail server 12 that receives information from the client 11. The mail server 12 first acquires a transmission document, broadcast transmission destination, and information of the keyword table 16 (step S31), and it also acquires the mail address and emphasis keyword of one receiver corresponding to the broadcast transmission destination from the keyword table 16 (step S32).

Next, the mail server 12 retrieves the transmission document. If a character string that matches the acquired emphasis keyword is present, the transmission document that emphasizes and highlights the character string is prepared to be stored in the area corresponding to the mail address in the mailbox 14 (step S33). If such a character string is not present at that time, the transmission document is directly stored in the mailbox 14.

Since “The management department” is designated as the emphasis keyword, for example, in the case of “Yamada” of FIG. 17, the same character string as that included in the transmission document of FIG. 16 is emphasized and highlighted to be stored in the area corresponding to the mail address of “Yamada”.

Next, it is checked whether the next receiver corresponding to the broadcast transmission destination is registered in the keyword table 16 (step S34). If such a receiver is remaining, the processes in and after step S32 are repeated. When the transmission documents of all the receivers of the broadcast transmission destination are stored in the mailbox 14, these transmission documents are transmitted to the client 13 as mail (step S35), and the processes terminate.

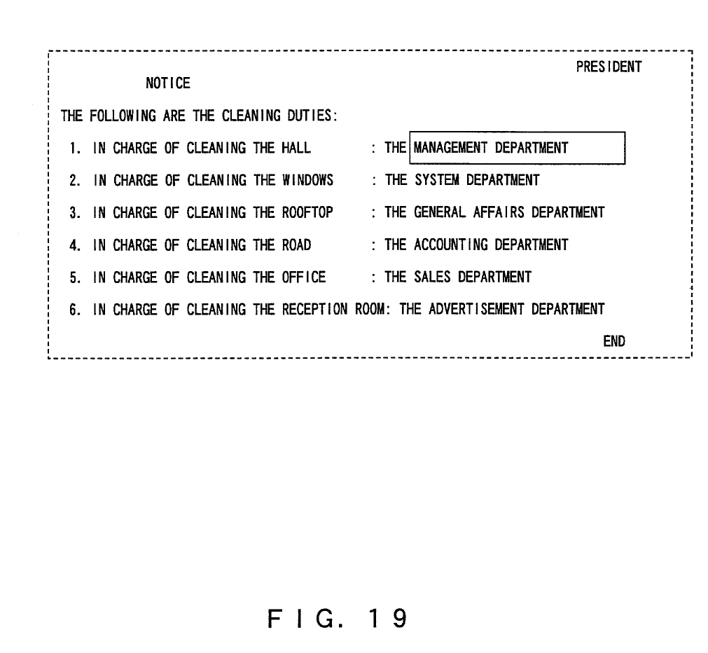

Received mail as shown in FIGS. 19, 20, 21, 22, 23, and 24, is displayed on the client screens of “Yamada”, “Tamura”, “Murayama”, “Yamakawa”, “Kawakami”, and “Uemura”, respectively, that are the broadcast transmission destinations of the “Conference A” of FIG. 17. In this received mail, the parts corresponding to the emphasis keywords of the respective receivers are enclosed in rectangular frames, to be emphasized and displayed.

According to such a transmitting process, the system automatically determines the receiver and part to be emphasized and highlighted. Therefore, the sender need not input a transmission destination of the emphasized part. The keyword table 16 may be amended only if necessary, so that it need not be prepared each time a transmission document is prepared. Therefore, the receiver can have the same convenience as that shown in FIG. 3.

In the above-mentioned embodiment, examples of sending minutes and notification using the broadcast E-mail are explained. The present invention is not limited to these examples, but the invention can be applied to the transmission of an optional transmission document. For example, in the case that notification of the list of successful candidates of a test is made to all successful candidates, the name and other information about successful candidate of each group which is included in the successful candidate list, is emphasized and displayed, to be sent to the corresponding successful candidate.

The clients 11 and 13, and the mail server 12 of FIG. 2 can be configured using, for example, the information processor (computer) as shown in FIG. 25. The information processor of FIG. 25 is provided with a CPU (central processing unit) 21, memory 22, input apparatus 23, output apparatus 24, external storage apparatus 25, medium driving apparatus 26, and network connecting apparatus 27, which are connected by a bus 28.

The memory 22 includes, for example, a ROM (read only memory), RAM (random access memory), etc., and stores the program and data that are used for processes. The CPU 21 performs required processes, by running the program using the memory 22.

The input apparatus 23 includes, for example, a keyboard, pointing device, touch panel, etc., and it is used for inputting the indication and information transmitted from an operator (sender, receiver, or the manager of a server). The output apparatus 24 includes, for example, a display, printer, loud speaker, etc., and it is used for outputting the inquiry and process result to an operator.

The external storage apparatus 25 includes, for example, a magnetic disk apparatus, optical disk apparatus, magneto-optical disk apparatus, tape apparatus, etc. The information processor stores the above-mentioned program and data in the external storage apparatus 25, and loads them into the memory 22 to be used if necessary. The mailbox 14 of FIG. 2 is installed, for example, in the external storage 25.

The medium driving apparatus 26 drives a portable storage medium 29, and accesses the recorded contents. As the portable storage medium 29, an optional computer-readable storage medium such as a memory card, floppy disk, CD-ROM (compact disk read only memory), optical disk, magneto-optical disk, or the like is used. An operator stores the above-mentioned program and data in the portable storage medium 29, and loads them into the memory 22 to be used if necessary.

The network connecting apparatus 27 is connected with other optional communication networks such as the Internet, and it sends/receives E-mail. Further, the information processor receives the above-mentioned program and data from other apparatuses through the network connecting apparatus 27, and the information processor loads them into the memory 22 to be used if necessary.

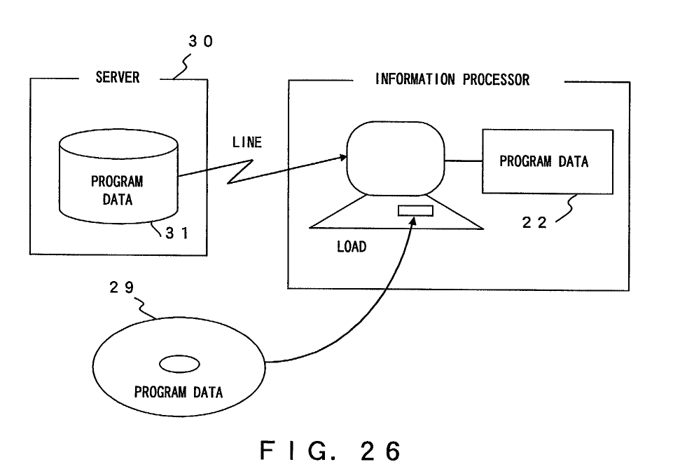

FIG. 26 shows a computer-readable storage medium that can supply a program and data to the information processor of FIG. 25. The program and data that are stored in the portable storage medium 29 and a database 31 of a server 30, are loaded into the memory 22. At this time, the server 30 generates a conveying signal for conveying the program and data, and transmits the signal to the information processor through an optional transmitting medium on a network. Then, the CPU 21 executes the program using the data, thereby performing the required process.

According to the present invention, the important part to each receiver of the broadcast E-mail is automatically emphasized and displayed. Therefore, the receiver can easily recognize the important part, so that he or she can read many E-mails effectively. Further, a sender can send the E-mail with the emphasized part that differs for every receiver, even if the sender does not prepare individual E-mail for each receiver.

What is claimed is:

1. An E-mail system comprising:
a receiving device receiving transmission information transmitted from a sender to a plurality of receivers;
an emphasizing device emphasizing and highlighting the transmission information for each receiver, and preparing E-mail information for each receiver; and
a transmitting device transmitting the E-mail information for each receiver.

2. The E-mail system according to claim 1, wherein the receiving device receives a part of the transmission information that the sender designates and information about a corresponding transmission destination, and the emphasizing device emphasizes and highlights the designated part and prepares E-mail information for a receiver corresponding to the transmission destination.

3. The E-mail system according to claim 1, further comprising a storing device storing keyword information predetermined for each receiver, wherein
the emphasizing device emphasizes and highlights a part including the keyword information when the keyword information is included in the transmitted information, and prepares E-mail information for a receiver corresponding to the keyword information.

4. A terminal apparatus comprising:
a transmitting device transmitting transmission information prepared for a plurality of receivers; and
an indication device indicating E-mail information that emphasizes and highlights the transmission information for each receiver, to be sent to each receiver.

5. A computer-readable recording medium recording a program causing a computer to perform:
receiving transmission information from a sender to a plurality of receivers;
emphasizing and highlighting the transmission information for each receiver;
preparing E-mail information for each receiver; and
transmitting the E-mail information for each receiver.

6. An E-mail transmitting method comprising:
preparing transmission information to be transmitted from a sender to a plurality of receivers;
emphasizing and emphasizing the transmission information for each receiver;
preparing E-mail information for each receiver;
transmitting the E-mail information for each receiver; and
emphasizing and displaying the transmission information for each receiver.

7. An E-mail system comprising:
receiving means for receiving transmission information transmitted from a sender to a plurality of receivers;
emphasizing means for emphasizing and emphasizing the transmission information for each receiver, and preparing E-mail information for each receiver; and
transmitting means for transmitting the E-mail information for each receiver.

8. A propagating signal propagating a program for a computer to the computer, said program causing the computer to perform:
receiving transmission information transmitted from a sender to a plurality of receivers;
emphasizing and highlighting the transmission information for each receiver and preparing E-mail information for each receiver; and
transmitting the E-mail information for each receiver.
